(19) United States
(12) Patent Application Publication
(10) Pub. No.: US 2014/0106270 A1
(43) Pub. Date: Apr. 17, 2014

(54) TRANSPARENT ELECTROSTATIC CHARGE IMAGE DEVELOPING TONER, METHOD OF MANUFACTURING THE SAME, ELECTROSTATIC CHARGE IMAGE DEVELOPER, TONER CARTRIDGE, IMAGE FORMING METHOD, AND IMAGE FORMING APPARATUS

(71) Applicant: FUJI XEROX CO., LTD., Tokyo (JP)

(72) Inventors: Yuki TAKAMIYA, Kanagawa (JP); Tsuyoshi MURAKAMI, Kanagawa (JP); Eisuke IWAZAKI, Kanagawa (JP); Satoshi INOUE, Kanagawa (JP)

(73) Assignee: FUJI XEROX CO., LTD., Tokyo (JP)

(21) Appl. No.: 13/875,770

(22) Filed: May 2, 2013

(30) Foreign Application Priority Data
Oct. 16, 2012 (JP) 2012-228821

(51) Int. Cl. G03G 9/00; G03G 15/08

(52) U.S. Cl. CPC G03G 9/08755; G03G 9/0817; G03G 15/0865; G03G 9/08
USPC 430/105; 399/252; 430/108.3; 430/137.2

(57) ABSTRACT

A transparent electrostatic charge image developing toner includes a binder resin and a compound represented by the following Formula (1):

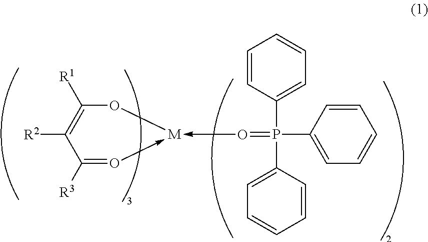

wherein in Formula (1), R¹ represents a methyl group or a trifluoromethyl group; R² represents a hydrogen atom; R³ represents a methyl group, a trifluoromethyl group, a t-butyl group, a phenyl group, or a naphthyl group; and M represents a rare earth element.

### CROSS-REFERENCE TO RELATED APPLICATIONS

This application is based on and claims priority under 35 USC 119 from Japanese Patent Application No. 2012-228821 filed Oct. 16, 2012.

### BACKGROUND

1. Technical Field

The present invention relates to a transparent electrostatic charge image developing toner, a method of manufacturing the transparent electrostatic charge image developing toner, an electrostatic charge image developer, a toner cartridge, an image forming method, and an image forming apparatus.

2. Related Art

Currently, a method of visualizing image information through an electrostatic charge image, such as electrophotography has been used in various fields.

In the related electrophotography, a method of performing visualization through plural processes of: forming an electrostatic latent image on a photoreceptor or an electrostatic recording member using various units; developing the electrostatic latent image (toner image) by adhering voltage-detection particles that are referred to as a toner to the electrostatic latent image; transferring the toner image onto a surface of a transfer medium; and fixing the toner image by heating or the like is generally used.

In recent years, in order to adjust gloss of an image, a technique of forming an image using a toner, obtained by removing a colorant component from a common color toner, that is referred to as a transparent toner or a clear toner has been considered.

### SUMMARY

According to an aspect of the invention, there is provided a transparent electrostatic charge image developing toner which includes a binder resin and a compound represented by the following Formula (1):

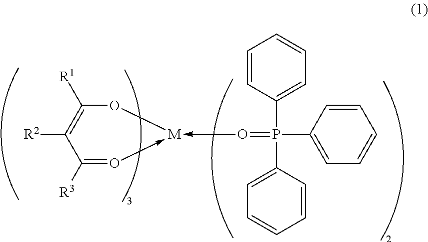

wherein in Formula (1), R¹ represents a methyl group or a trifluoromethyl group; R² represents a hydrogen atom; R³ represents a methyl group, a trifluoromethyl group, a t-butyl group, a phenyl group, or a naphthyl group; and M represents a rare earth element.

### BRIEF DESCRIPTION OF THE DRAWINGS

Exemplary embodiments of the present invention will be described in detail based on the following figures, wherein:

FIG. 1 is a diagram illustrating a screw state of an example of a screw extruder that is preferably used in manufacturing of a transparent electrostatic charge image developing toner of an exemplary embodiment;

FIG. 2 is a schematic diagram showing the configuration of an example of an image forming apparatus that is preferably used in the exemplary embodiment; and

FIG. 3 is a schematic diagram showing the configuration of an example of a process cartridge that is preferably used in the exemplary embodiment.

### DETAILED DESCRIPTION

Transparent Electrostatic Charge Image Developing Toner

A transparent electrostatic charge image developing toner (hereinafter, also simply referred to as “toner” or “transparent toner”) of an exemplary embodiment contains a binder resin and a compound represented by the following Formula (1) (hereinafter, also referred to as “compound (1)”).

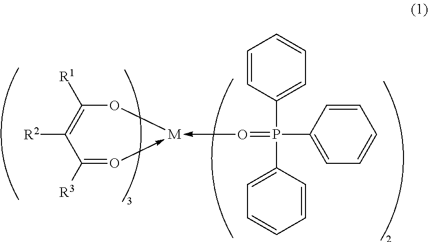

In Formula (1), R¹ represents a methyl group or a trifluoromethyl group, R² represents a hydrogen atom, R³ represents a methyl group, a trifluoromethyl group, a t-butyl group, a phenyl group, or a naphthyl group, and M represents a rare earth element.

In this exemplary embodiment, “X to Y” represents a range including not only a range between X and Y, but also X and Y at both ends of the range. For example, when “X to Y” is a numerical value range, it represents “equal to or greater than X and equal to or less than Y” or “equal to or greater than Y and equal to or less than X” in accordance with the sizes of the numerical values.

In this exemplary embodiment, “transparent electrostatic charge image developing toner” means that, regardless of the color of the toner itself, an obtained image is transparent in a visible light range. That is, the toner itself may be tinged with white, or slightly tinged with yellow, blue or the like, but an image after fixing is transparent in a visible light range (wavelength of about 400 nm to 800 nm).

“Transparent in a visible light range” means that the transmittance of light in a visible range is 10% or greater, and the transmittance is more preferably 75% or greater. The transmittance is preferably measured by creating an image that is the same as that to be used in a gloss evaluation in examples. The transparent toner of this exemplary embodiment means a toner that does not contain a colored colorant (color pigment, color dye, black carbon particles, black magnetic powder, and the like) designed for coloring due to visible light absorption or visible light scattering, or a toner that contains a very small amount of a colored colorant so that coloring due to visible light absorption or visible light scattering is not confirmed by the naked eye. Accordingly, the transparent electrostatic charge image developing toner of this exemplary embodiment is preferably a transparent toner having no color although transparency may be slightly reduced in accordance with the types, amounts, and the like of the various components contained in the toner.

As described in JP-A-11-7174 and JP-A-2011-197369, the gloss is adjusted by providing a transparent toner layer as a top layer of an image layer on a recording medium. In this case, when a toner image is transferred from a transfer medium to a final recording medium, the transparent toner layer is positioned as a bottom layer on the transfer medium, and becomes a top layer on the recording medium by transfer. When the transparent toner layer is provided in this manner, a transfer failure of the color toner layer is rectified.

However, when the transparent toner layer is provided, there is a problem in that a failure occurs in the transparent toner transfer. The inventors of the invention have found that particularly, under a high-temperature and high-humidity environment, a failure easily occurs in the transfer of the transparent toner layer that is a bottom layer on the transfer medium. The detailed mechanism thereof is not clear. However, it is thought that deterioration easily occurs in charging of the transparent toner layer that is a bottom layer, and particularly, the deterioration in charging is markedly exhibited at a high temperature and a high humidity.

The inventors of the invention have conducted an intensive study, and as a result, found that when a specific organometallic complex (compound represented by Formula (1)) is added to a toner, transferability under a high-temperature and high-humidity environment is improved, and completed the invention. Furthermore, they have found that gloss unevenness that occurs due to the transfer failure is corrected and an image having high gloss and high smoothness may thus be obtained. The detailed mechanism thereof is not clear. However, it is presumed that the triphenylphosphine oxide group in the structure of the compound represented by Formula (1) is a functional group that is stable with respect to an atmospheric change, the toner is inhibited from absorbing the moisture under a high-temperature and high-humidity environment, a favorable charging property is maintained, and as a result, transferability under the high-temperature and high-humidity environment is enhanced.

Hereinafter, the components of the toner will be described in detail.

Compound Represented by Formula (1)

The transparent electrostatic charge image developing toner of this exemplary embodiment contains a compound represented by Formula (1) (compound (1)). When the transparent electrostatic charge image developing toner of this exemplary embodiment contains the compound (1), transferability under a high-temperature and high-humidity environment is enhanced. It is presumed that since the compound (1) has the triphenylphosphine oxide group as described above, the toner is inhibited from absorbing the moisture and the transferability is enhanced.

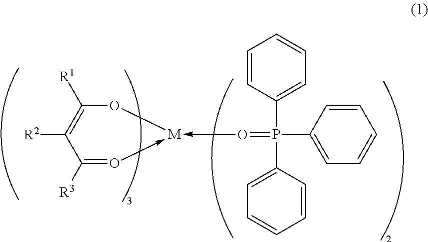

In Formula (1), R¹ represents a methyl group or a trifluoromethyl group, R² represents a hydrogen atom, R³ represents a methyl group, a trifluoromethyl group, a t-butyl group, a phenyl group, or a naphthyl group, and M represents a rare earth element.

The β-diketone group is known to be excited to a high-energy level when electrons in the conjugated system absorb photons of light with an appropriate wavelength. Since there is a high possibility that the compound may be degraded due to the excitation, it is desirable that adjacent functional groups be composed of an atom and a bond that are resistant to excitation oscillation.

In Formula (1), R¹ represents a methyl group or a trifluoromethyl group, and is preferably a trifluoromethyl group from the above-described viewpoint.

In Formula (1), R² represents a hydrogen atom. Deuterium (²H, D) may be used as the hydrogen atom, and the hydrogen atom is not particularly limited.

In Formula (1), R³ represents a methyl group, a trifluoromethyl group, a t-butyl group, a phenyl group, or a naphthyl group. The phenyl group and the naphthyl group may have a substituent, and as the substituent, an alkyl group and an alkoxy group are exemplified. The alkyl group and the alkoxy group may be substituted by a halogen atom.

From the above-described viewpoint, regarding R³, a halogen atom or a carbon atom is preferable, and a. halogen atom is more preferable as an atom (atom 2) that is bonded to a carbon atom (C1) close to a ketone group. Furthermore, a bond between C1 and atom 2 is preferably a single bond. Based on the viewpoints, a trifluoromethyl group, a t-butyl group, a phenyl group, or a naphthyl group is preferable, a trifluoromethyl group or a t-butyl group is more preferable, and a trifluoromethyl group is even more preferable.

M represents a rare earth element in Formula (1), and specific examples thereof include scandium (Sc), yttrium (Y), and those belonging to a lanthanoid group, which are lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), and ruthenium (Lu). Among them, yttrium, europium, terbium, and samarium are preferably used, europium, terbium, and samarium are more preferably used, and europium is even more preferably used from the viewpoint of availability and effects.

When the above-described specific elements, atoms, and groups are selected as M, R¹, R², and R³, toner coloring is inhibited and a transparent toner layer having high transparency is obtained.

In this exemplary embodiment, a content of the rare earth element in the toner measured by fluorescent X-ray analysis is preferably 0.2% by weight to 1.5% by weight, more preferably 0.3% by weight to 1.0% by weight, and even more preferably 0.4% by weight to 0.8% by weight. The content of the rare earth element in the toner is correlated with the content of the compound (1), and the amount of the compound (1) is preferably adjusted to set the content of the rare earth element in the above range.

When the content of the rare earth element is 0.2% by weight or greater, an image having high gloss and high smoothness is obtained. In addition, when the content of the rare earth element is 1.5% by weight or less, an image having high gloss is obtained without an increase of a minimum fixing temperature. Moreover, the compound (1) is a light-color compound that is extremely close to colorless, and since a problem such as image coloring does not easily occur, the content of the rare earth element is preferably 1.5% by weight or less.

In addition, although depending on the molecular weight of the compound (1), a content of the compound (1) in the transparent electrostatic charge image developing toner of this exemplary embodiment is preferably 2% by weight to 15% by weight, more preferably 4% by weight to 10% by weight, and even more preferably 3% by weight to 7% by weight in order to achieve the above-described content of the rare earth element.

In the transparent electrostatic charge image developing toner of this exemplary embodiment, when a content of the rare earth element in the toner measured by fluorescent X-rays is represented by A₁% by weight, and a content of phosphorus in the toner measured by fluorescent X-rays is represented by A₂% by weight, A₂/A₁ is preferably 0.2 to 1.5, more preferably 0.25 to 1.2, and even more preferably 0.3 to 0.9.

In some cases, an excessive amount of the triphenylphosphine oxide group remains in the synthesis of the compound (1). In this case, the value of A₂/A₁ in the toner is greater than the theoretical value of the case in which the compound (1) is added. Since a favorable charging property is obtained, A₂/A₁ is preferably in the above range.

Here, the method of measuring the content A₁ (wt %) of the rare earth element in the toner and the content A₂ (wt %) of the phosphorus in the toner by fluorescent X-ray analysis are as follows. Using a scanning X-ray fluorescence spectrometer (Rigaku ZSX Primus II), a disk having a toner amount of 0.130 g is molded, and under the conditions of an X-ray output of 40 mA to 70 mA, a measurement area of 10 mmφ, and a measurement time of 15 minutes, the measurement is performed through a qualitative and quantitative total elemental analysis method. The analysis value of the data of the measurement is set as an element amount of this exemplary embodiment. When a peak of the target element and a peak of another element overlap each other, analysis by ICP emission spectrometry or an atomic absorption method is performed to obtain the analysis value.

The method of synthesizing the compound (1) is not particularly limited, and a known method may be employed. See the method described in JP-A-2001-354953. Specifically, in an alcohol or an acetone solvent, a triphenylphosphine oxide and a propanedione derivative represented by Formula (1′) may be reacted with europium perchlorate or europium chloride in the presence of sodium hydroxide at preferably 0° C. to 80° C. to synthesize the compound (1).

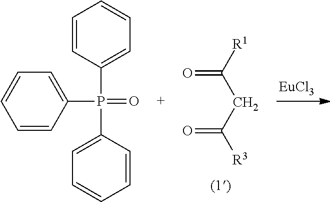

In Formula (1′), R¹ and R³ are the same as those in Formula (1), and preferable ranges thereof are also the same as in the case of Formula (1).

Binder Resin

The toner contains a binder resin.

A polyester resin is preferably used as the binder resin in this exemplary embodiment. Since a polyester resin is hydrophilic, it is dispersed well in the formation of the toner, and the europium complex may be taken in toner base particles in a more uniform state. Therefore, a polyester resin is preferably used.

A polyester resin and a polyamide resin are preferably exemplified as a polycondensation resin, and particularly, a polyester resin that is obtained using a material containing a polycarboxylic acid and polyol as a polycondensable monomer is preferably used.

Examples of the polycondensable monomer that may be used in this exemplary embodiment include polycarboxylic acids, polyols, hydroxycarboxylic acids, polyamines, and mixtures thereof. Particularly, as the polycondensable monomer, polycarboxylic acids, polyols, and ester compounds thereof (oligomer and/or prepolymer) are preferably used, and those with which a polyester resin may be obtained through a direct ester reaction or an ester exchange reaction are preferable. In this case, a polyester resin to be polymerized may have any form such as an amorphous polyester resin (non-crystalline polyester resin), a crystalline polyester resin, or a mixed form thereof.

In this exemplary embodiment, the polycondensation resin is obtained by polycondensing at least one type selected from the group consisting of polycondensable monomers and oligomers and prepolymers thereof. Among them, polycondensable monomers are preferably used.

The polycarboxylic acid is a compound containing two or more carboxyl groups in a molecule. Among polycarboxylic acids, a dicarboxylic acid is a compound containing two carboxyl groups in a molecule, and examples thereof include succinic acid, glutaric acid, maleic acid, adipic acid, β-methyl adipic acid, azelaic acid, sebacic acid, nonanedicarboxylic acid, decanedicarboxylic acid, undecanedicarboxylic acid, dodecanedicarboxylic acid, fumaric acid, citraconic acid, diglycol acid, cyclohexane-3,5-diene-1,2-carboxylic acid, hexahydroterephthalic acid, malonic acid, pimelic acid, suberic acid, phthalic acid, isophthalic acid, terephthalic acid, tetrachlorophthalic acid, chlorophthalic acid, nitrophthalic acid, p-carboxyphenylacetic acid, p-phenylene diacerate, m-phenylene diacerate, o-phenylene diacerate, diphenylacetic acid, diphenyl-p,p′-dicarboxylic acid, naphthalene-1,4-dicarboxylic acid, naphthalene-1,5-dicarboxylic acid, naphthalene-2,6-dicarboxylic acid, anthracenedicarboxylic acid, and cyclohexanedicarboxylic acid.

In addition, examples of the polycarboxylic acids other than dicarboxylic acids include trimellitic acid, trimesic acid, pyromellitic acid, naphthalene tricarboxylic acid, naphthalene tetracarboxylic acid, pyrenetricarboxylic acid, pyrenetetracarboxylic acid, itaconic acid, glutaconic acid, n-dodecylsuccinic acid, n-dodecenylsuccinic acid, isododecylsuccinic acid, isododecenylsuccinic acid, n-octylsuccinic acid, n-octenylsuccinic acid, and lower esters thereof, as well as acid halides and acid anhydrides thereof.

These may be used singly or in combination of two or more types.

The lower esters are esters in which the alkoxy part of the ester has 1 to 8 carbon atoms. Specific examples thereof include methyl esters, ethyl esters, n-propyl esters, isopropyl esters, n-butyl esters, and isobutyl esters.

The polyol is a compound containing two or more hydroxyl groups in a molecule. Among polyols, a diol is a compound containing two hydroxyl groups in a molecule, and specific examples of the diol include ethylene glycol, diethylene glycol, triethylene glycol, 1,2-propylene glycol, 1,3-propylene glycol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, 1,14-eicosanedecanediol, diethylene glycol, triethylene glycol, dipropylene glycol, polyethylene glycol, polypropylene glycol, polytetramethylene ether glycol, 1,4-cyclohexanediol, 1,4-cyclohexanedimethanol, 1,4-butenediol, neopentyl glycol, polytetramethylene glycol, hydrogenated bisphenol-A, bisphenol-A, bisphenol-F, bisphenol-S, and alkylene oxide (ethylene oxide, propylene oxide, butylene oxide, and the like) adducts of the above bisphenols. Among them, alkylene glycol with 2 to 12 carbon atoms and alkylene oxide adducts of bisphenols are preferably used, and alkylene oxide adducts of bisphenols and combinations of alkylene glycol with 2 to 12 carbon atoms with the alkylene oxide adducts of bisphenols are particularly preferably used.

In addition, 2,2-dimethylol propionic acid, 2,2-dimethylol butanoic acid, and 2,2-dimethylol valeric acid are exemplified as a material for higher water dispersibility.

Examples of tri- or higher-valent alcohols include glycerin, trimethylolethane, trimethylolpropane, pentaerythritol, hexamethylol melamine, hexaethylol melamine, tetramethylol benzoguanamine, tetraethylol benzoguanamine, sorbitol, trisphenol PA, phenol novolac, cresol novolac, and alkylene oxide adducts of the tri- or higher-valent polyphenols. These may be used singly or in combination of two or more types.

In addition, an amorphous resin and a crystalline resin may be easily obtained by combination of the polycondensable monomers.

In addition, a hydroxycarboxylic acid may also be used. Specific examples of the hydroxycarboxylic acid include hydroxyheptanoic acid, hydroxyoctanoic acid, hydroxydecanoic acid, hydroxyundecanoic acid, malic acid, tartaric acid, mucic acid, and citric acid.

In addition, examples of the polyamine include ethylenediamine, diethylenediamine, 1,2-propanediamine, 1,3-propanediamine, 1,4-butanediamine, 1,4-butenediamine, 2,2-dimethyl-1,3-butanediamine, 1,5-pentanediamine, 1,6-hexanediamine, 1,4-cyclohexanediamine, and 1,4-cyclohexanebis(methylamine).

In addition, the weight average molecular weight of the polycondensation resin that is obtained by polycondensation of a polycondensable monomer is preferably 1,500 to 40,000, and more preferably 3,000 to 30,000. Since the binder resin has a favorable cohesive force and an excellent hot offset property, the weight average molecular weight is preferably 1,500 or greater, and since an excellent offset property is obtained and an excellent minimum fixing temperature is shown, the weight average molecular weight is preferably 40,000 or less. In addition, partial branching, cross-linking and the like may be achieved by selection of carboxylic acid valence and alcohol valence of the monomer.

In addition, the acid value of the obtained polyester resin is preferably 1 mg·KOH/g to 50 mg·KOH/g. A first reason for this is that the toner particle diameter and the distribution in an aqueous medium are required to be controlled for practical use as a high-image quality toner, and when the acid value is 1 mg·KOH/g or greater, a sufficient particle diameter and distribution may be achieved in the granulation process. Furthermore, a sufficient charging property may be obtained when the polyester resin is used in the toner. When the acid value of polyester to be polycondensed is 50 mg·KOH/g or less, a sufficient molecular weight for obtaining an image quality strength for the toner may be obtained in the polycondensation. In addition, the dependence of the charging property of the toner on environment at high humidity is also reduced and excellent image reliability is obtained.

A glass transition temperature Tg of the polyester resin is preferably 50° C. to 80° C., and more preferably 50° C. to 65° C. When Tg is 50° C. or higher, the binder resin itself has a favorable cohesive force in a high-temperature region, and thus the hot offset property is excellent in the fixing. In addition, when Tg is 80° C. or lower, melting is carried out sufficiently and the minimum fixing temperature does not rise easily.

The glass transition temperature of the binder resin is a value measured using a method (DSC method) specified in ASTM D3418-82.

A cationic polymerizable monomer and a radical polymerizable monomer are exemplified as an addition polymerizable monomer that is used in the preparation of an addition polymerization-type resin, and a radical polymerizable monomer is preferably used.

Examples of the radical polymerizable monomer include styrene-based monomers, unsaturated carboxylic acids, (meth)acrylates (“(meth)acrylates” means acrylates and methacrylates, and the same shall apply hereinafter), N-vinyl compounds, vinyl esters, halogenated vinyl compounds, N-substituted unsaturated amides, conjugated dienes, multifunctional vinyl compounds, and multifunctional (meth)acrylates. Among them, N-substituted unsaturated amides, conjugated dienes, multifunctional vinyl compounds, and multifunctional (meth)acrylates may cause a cross-linking reaction of the generated polymer. These may be used singly or in combination.

Examples of the addition polymerizable monomer that may be used in this exemplary embodiment include a radical polymerizable monomer, a cationic polymerizable monomer and an anionic polymerizable monomer, and a radical polymerizable monomer is preferably used.

The radical polymerizable monomer is preferably a compound having an ethylenic unsaturated bond, and more preferable examples thereof include aromatic ethylenic unsaturated compounds (hereinafter, also referred to as “vinyl aromatics”), carboxylic acids having an ethylenic unsaturated bond (unsaturated carboxylic acids), derivatives of unsaturated carboxylic acids such as esters, aldehydes, nitriles and amides, N-vinyl compounds, vinyl esters, halogenated vinyl compounds, N-substituted unsaturated amides, conjugated dienes, polyfunctional vinyl compounds and polyfunctional (meth)acrylates.

Specific examples thereof include unsubstituted vinyl aromatics such as styrene and p-vinylpyridine, vinyl aromatics such as α-substituted styrenes, e.g., α-methylstyrene and α-ethylstyrene, aromatic-nucleus-substituted styrenes, e.g., m-methylstyrene, p-methylstyrene, and 2,5-dimethylstyrene, and aromatic-nucleus halogen-substituted styrenes, e.g., p-chlorostyrene, p-bromostyrene, and dibromostyrene, unsaturated carboxylic acids such as (meth)acrylic acid (“(meth)acryl” means acryl and methacryl, and the same shall apply hereinafter), crotonic acid, maleic acid, fumaric acid, citraconic acid, and itaconic acid, unsaturated carboxylic acid esters such as methyl(meth)acrylate, ethyl(meth)acrylate, propyl(meth)acrylate, butyl(meth)acrylate, pentyl(meth)acrylate, hexyl(meth)acrylate, 2-ethylhexyl(meth)acrylate, glysidyl(meth)acrylate, and benzyl(meth)acrylate, unsaturated carboxylic acid derivatives such as (meth)acrylic aldehyde, (meth)acrylonitrile, and (meth)acrylamide, N-vinyl compounds such as N-vinyl pyridine and N-vinyl pyrrolidone, vinyl esters such as vinyl formate, vinyl acetate, and vinyl propionate, halogenated vinyl compounds such as vinyl chloride, vinyl bromide, and vinylidene chloride, N-substituted unsaturated amides such as N-methylolacrylamide, N-ethylolacrylamide, N-propanolacrylamide, N-methylolmaleinamide acid, N-methylolmaleinamide acid ester, N-methylolmaleinimide, and N-ethylolmaleinimide, conjugated dienes such as butadiene and isoprene, multifunctional vinyl compounds such as divinylbenzene, divinyl naphthalene, and divinyl cyclohexane, and multifunctional acrylates such as ethylene glycol di(meth)acrylate, diethylene glycol di(meth)acrylate, propylene glycol di(meth)acrylate, tetramethylene glycol di(meth)acrylate, neopentyl glycol di(meth)acrylate, hexamethylene glycol di(meth)acrylate, trimethylolpropane di(meth)acrylate, trimethylolpropane tri(meth)acrylate, glycerol di(meth)acrylate, glycerol tri(meth)acrylate, pentaerythritol di(meth)acrylate, pentaerythritol tri(meth)acrylate, pentaerythritol tetra(meth)acrylate, dipentaerythritol di(meth)acrylate, dipentaerythritol tri(meth)acrylate, dipentaerythritol tetra(meth)acrylate, dipentaerythritol penta(meth)acrylate, dipentaerythritol hexa(meth)acrylate, sorbitol tri(meth)acrylate, sorbitol tetra(meth)acrylate, sorbitol penta(meth)acrylate, and sorbitol hexa(meth)acrylate. In addition, a sulfonic acid and a phosphonic acid having an ethylenic unsaturated bond, and derivatives thereof may also be used. Among them, N-substituted unsaturated amides, conjugated dienes, multifunctional vinyl compounds, and multifunctional acrylates may cause a cross-linking reaction of the generated polymer. The addition polymerizable monomers may be used singly or in combination of two or more types.

In addition, the content of the binder resin in the toner of this exemplary embodiment is preferably 10% by weight to 90% by weight, more preferably 30% by weight to 85% by weight, and even more preferably 50% by weight to 80% by weight with respect to the total weight of the toner.

Release Agent

The transparent electrostatic charge image developing toner of this exemplary embodiment preferably contains a release agent.

As the release agent, ester wax, polyethylene, polypropylene, or a copolymer of polyethylene and polypropylene is preferably exemplified, and specific examples thereof include waxes such as polyglycerin wax, microcrystalline wax, paraffin wax, carnauba wax, Sasol wax, montanic acid ester wax, and deoxidized carnauba wax; unsaturated fatty acids such as palmitic acid, stearic acid, montanic acid, brassidic acid, eleostearic acid, and parinaric acid; saturated alcohols such as stearyl alcohol, aralkyl alcohol, behenyl alcohol, carnaubyl alcohol, ceryl alcohol, melissyl alcohol, and long-chain alkyl alcohols having a long-chain alkyl group; polyhydric alcohols such as sorbitol; fatty acid amides such as linoleic acid amide, oleic acid amide, and lauric acid amide; saturated fatty acid bisamides such as methylenebisstearic acid amide, ethylenebiscapric acid amide, ethylenebislauric acid amide, and hexamethylenebisstearic acid amide; unsaturated fatty acid amides such as ethylenebisoleic acid amide, hexamethylenebisoleic acid amide, N,N′-dioleyladipic acid amide, and N,N′-dioleylcebasic acid amide; aromatic bisamides such as m-xylenebisstearic acid amide and N,N′-distearylisophthalic acid amide; fatty acid metal salts (those generally called metal soaps) such as calcium stearate, calcium laurate, zinc stearate, and magnesium stearate; waxes obtained by grafting of a vinyl-based monomer such as styrene and acrylic acid to aliphatic hydrocarbon-based wax; partially esterified products of a fatty acid and polyhydric alcohol such as behenic acid monoglyceride; and methyl ester compounds having a hydroxyl group that is obtained by hydrogenating vegetable oil.

The release agent may be used singly or in combination of two or more types. The release agent is preferably contained in the range of 1% by weight to 20% by weight, and more preferably 3% by weight to 15% by weight with respect to 100% by weight of the binder resin. When the content is in the above range, favorable fixing and image quality characteristics may be balanced.

Other Components

If necessary, other than the above-described components, various components such as a charge control agent, an inorganic powder (inorganic particles), and organic particles may be added to the toner.

Examples of the charge control agent include tetrafluorine-based surfactants, salicylic acid metal complexes, metal complex dyes such as azo-based metal compounds, polymer acids such as a polymer containing a maleic acid as a monomer component, quaternary ammonium salts, and azine-based dyes such as nigrosine.

External Additive

It is preferable that an external additive is externally added to surfaces of toner particles. Examples of the external additive that is externally added to the surface include inorganic particles and organic particles. Specifically, the following examples and the external additive that is used in a toner manufacturing method to be described later are also included.

Examples of the inorganic particles include silica, alumina, titanium oxide, barium titanate, magnesium titanate, calcium titanate, strontium titanate, zinc oxide, silica sand, clay, mica, wollastonite, diatomaceous earth, cerium chloride, red iron oxide, chromium oxide, cerium oxide, antimony trioxide, magnesium oxide, zirconium oxide, silicon carbide, and silicon nitride.

Generally, inorganic particles are used for the purpose of improving fluidity. The primary particle diameter of the inorganic particles is preferably 1 nm to 200 nm, and the added amount is preferably 0.01 parts by weight to 20 parts by weight with respect to 100 parts by weight of the toner.

Generally, organic particles are used for the purpose of improving cleanability and transferability, and specific examples thereof include fluorine-based resin powders such as polyvinylidene fluoride and polytetrafluoroethylene, fatty acid metal salts such as zinc stearate and calcium stearate, polystyrene, and polymethyl methacrylate.

Among the above-described external additives, inorganic oxides such as titania and silica are preferably used from the viewpoint of improvement in fluidity and charging characteristics.

The amount of the external additive is preferably 0.1 part by weight to 5 parts by weight with respect to 100 parts by weight of the toner particles before external addition. When the external addition amount is 0.1 part by weight or greater, an improvement in fluidity and charging property due to the external additive is shown. When the external addition amount is 5 parts by weight or less, a sufficient charging property is provided.

Toner Properties

A volume average particle diameter Dv (D₅₀ᵥ) of the toner of this exemplary embodiment is preferably 3 μm to 20 μm, more preferably 3 μm to 15 μm and even more preferably 4 μm to 10 μm.

In addition, a volume average particle diameter Dv (D₅₀ᵥ) of the toner base particles in the toner of this exemplary embodiment is preferably 3 μm to 20 μm, more preferably 3 μm to 15 μm, and even more preferably 4 μm to 10 μm.

When the volume average particle diameter of the toner and the volume average particle diameter of the toner base particles are 3 μm or greater, contamination of a transfer medium (transfer belt) is inhibited, and when the volume average particle diameter of the toner and the volume average particle diameter of the toner base particles are 20 μm or less, an image having high gloss is obtained.

The particle size distribution of the toner is preferably narrow. More specifically, the value (GSDp) of the square root of the ratio of the 84% diameter (D₈₄ₚ) to the 16% diameter (D₁₆ₚ) converted from the smallest number diameter side of the toner, that is, GSDp that is expressed by the following formula is preferably 1.40 or less, more preferably 1.31 or less, and particularly preferably 1.27 or less. In addition, GSDp is even more preferably 1.15 or greater.

GSDp={(D₈₄ₚ)/(D₁₆ₚ)}^{0.5}

When both of the volume average particle diameter and GSDp are in the above ranges, respectively, extremely small particles are present in a small amount, and thus a reduction in developability due to an excessive charge amount of the small-particle-diameter toner may be suppressed.

A Coulter Multisizer II (manufactured by Beckman Coulter, Inc.) may be used in the measurement of the average particle diameter of particles such as toner. In this case, the measurement may be performed using an optimum aperture depending on the particle diameter level of the particles. The measured particle diameter of the particles is expressed by the volume average particle diameter.

When the particle diameter of the particles is about 5 μm or less, the measurement may be performed using a laser diffraction/scattering particle size distribution measuring device (LA-700, manufactured by Horiba, Ltd.).

Furthermore, when the particle diameter is a nanometer-order diameter, the measurement may be performed using a BET specific surface area measuring device (Flow Sorb II 2300, manufactured by Shimadzu Corporation).

In this exemplary embodiment, a shape factor SF1 of the toner is preferably 110 to 145, and more preferably 120 to 140.

The shape factor SF1 is a shape factor showing the degree of unevenness of the particle surface, and is calculated using the following expression.

$$SFI = \frac{{( M L )}^{2}}{A} \times \frac{π}{4} \times 100$$

In the expression, ML represents the maximum length of the particle, and A represents a projected area of the particle.

As a specific method of measuring the shape factor SF1, for example, first, an optical microscopic image of the toner sprayed on a glass slide is scanned to an image analyzer through a video camera, the shape factors SF1 of 50 toner particles are calculated, and an average value thereof is obtained.

Toner Preparation Method

The toner manufacturing method of this exemplary embodiment is not particularly limited. Toner particles are prepared using a dry method such as a known kneading pulverization method or a wet method such as an emulsion aggregation method or a suspension polymerization method, and if necessary, an external additive is externally added to the toner particles. Among the methods, a kneading pulverization method is preferably used.

The kneading pulverization method is a method including: kneading a toner forming material containing a binder resin to obtain a kneaded material; and pulverizing the kneaded material to prepare toner particles. When toner particles are prepared using the kneading pulverization method to obtain a toner, the complex powder is dispersed well and the smoothness and light emission luminance of an image are improved.

More specifically, the kneading pulverization method is divided into a kneading process of kneading a toner forming material containing a binder resin and a compound (1) and a pulverization process of pulverizing the kneaded material. If necessary, the kneading pulverization method may have other processes such as a cooling process of cooling the kneaded material formed by the kneading process.

A method of manufacturing the transparent electrostatic charge image developing toner according to the exemplary embodiment may include kneading a toner forming material containing the binder resin and the compound represented by Formula (1); cooling a kneaded material formed by the kneading; pulverizing the kneaded material cooled by the cooling; and classifying the kneaded material pulverized by the pulverizing.

Each process will be described in detail.

Kneading Process

The kneading process is a process of kneading a toner forming material containing a binder resin and a compound including a compound (1).

In the kneading process, it is preferable to add 0.5 part by weight to 5 parts by weight of an aqueous medium (for example, water such as distilled water or ion exchange water, alcohols, or the like) with respect to 100 parts by weight of the toner forming material.

Examples of a kneader that is used in the kneading process include a single-axis extruder and a two-axis extruder. Hereinafter, as an example of the kneader, a kneader having a sending screw portion and two kneading portions will be described using a diagram, but the example of the kneader is not limited thereto.

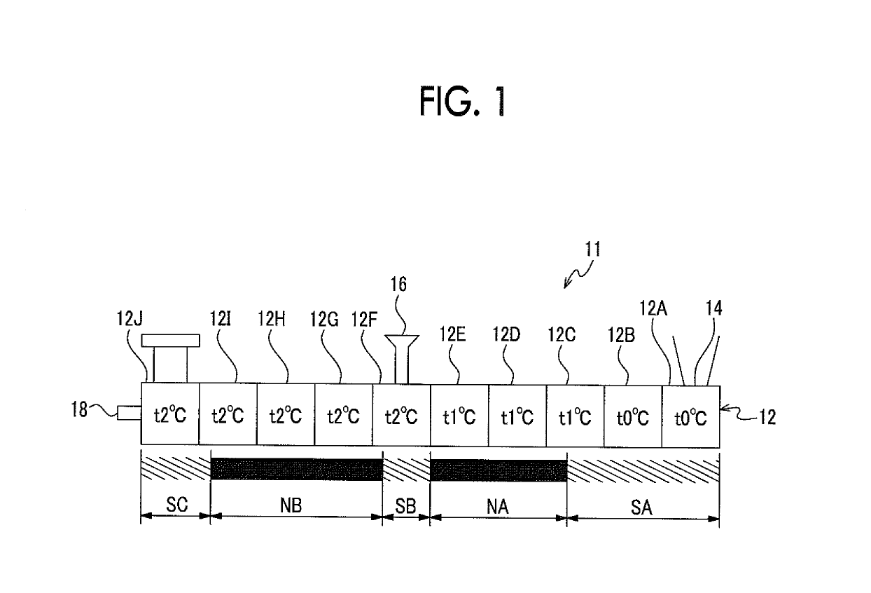

FIG. 1 is a diagram illustrating a screw state of an example of a screw extruder that is used in the kneading process of the toner manufacturing method of this exemplary embodiment.

A screw extruder 11 is constituted by a barrel 12 provided with a screw (not shown), an injection port 14 through which a toner forming material that is a raw material of the toner is injected to the barrel 12, a liquid addition port 16 for adding an aqueous medium to the toner forming material in the barrel 12, and a discharge port 18 through which the kneaded material formed by kneading the toner forming material in the barrel 12 is discharged.

The barrel 12 is divided into, in order of distance from the injection port 14, a sending screw portion SA that transports the toner forming material injected from the injection port 14 to a kneading portion NA, the kneading portion NA for melting and kneading the toner forming material by a first kneading process, a sending screw portion SB that transports the toner forming material melted and kneaded in the kneading portion NA to a kneading portion NB, the kneading portion NB that melts and kneads the toner forming material by a second kneading process to form the kneaded material, and a sending screw portion SC that transports the formed kneaded material to the discharge port 18.

In addition, in the barrel 12, a different temperature controller (not shown) is provided for each block. That is, the temperatures of blocks 12A to 12J may be controlled to be different from each other. FIG. 1 shows a state in which the temperatures of the blocks 12A and 12B are controlled to t0° C., the temperatures of the blocks 12C to 12E are controlled to t1° C., and the temperatures of the blocks 12F to 12J are controlled to t2° C. Therefore, the toner forming material in the kneading portion NA is heated to t1° C., and the toner forming material in the kneading portion NB is heated to t2° C.

When the toner forming material containing a binder resin, a compound (1), and if necessary, a release agent and the like is supplied to the barrel 12 from the injection port 14, the sending screw portion SA sends the toner forming material to the kneading portion NA. At this time, since the temperature of the block 12C is set to t1° C., the toner forming material melted by heating is fed to the kneading portion NA. In addition, since the temperatures of the blocks 12D and 12E are also set to t1° C., the toner forming material is melted and kneaded at a temperature of t1° C. in the kneading portion NA. The binder resin and the release agent are melted in the kneading portion NA and subjected to shear by the screw.

Next, the toner forming material kneaded in the kneading portion NA is sent to the kneading portion NB by the sending screw portion SB.

In the sending screw portion SB, an aqueous medium is added to the toner forming material by injecting the aqueous medium to the barrel 12 from the liquid addition port 16. In FIG. 1, the aqueous medium is injected in the sending screw portion SB, but the invention is not limited thereto. The aqueous medium may be injected in the kneading portion NB, or may be injected in both of the sending screw portion SB and the kneading portion NB. That is, the position at which the aqueous medium is injected and the number of injection positions are selected as necessary.

As described above, due to the injection of the aqueous medium to the barrel 12 from the liquid addition port 16, the toner forming material in the barrel 12 and the aqueous medium are mixed, and the toner forming material is cooled by evaporative latent heat of the aqueous medium, whereby the temperature of the toner forming material is properly maintained.

Finally, the kneaded material formed by melting and kneading in the kneading portion NB is transported to the discharge port 18 by the sending screw portion SC, and is discharged from the discharge port 18.

The kneading process using the screw extruder 11 shown in FIG. 1 is performed as described above.

Cooling Process

The cooling process is a process of cooling the kneaded material that is formed in the kneading process, and in the cooling process, the kneaded material is preferably cooled to 40° C. or lower from the temperature of the kneaded material upon the end of the kneading process at an average temperature decrease rate of 4° C./sec or higher. In some cases, when the cooling rate of the kneaded material is low, the mixture (mixture with an internal additive such as a release agent to be internally added into toner particles as necessary) finely dispersed in the binder resin in the kneading process is recrystallized and the dispersion diameter increases. Since the dispersion state immediately after the end of the kneading process is maintained as it is, it is preferable that the kneaded material is rapidly cooled at the average temperature decrease rate. The average temperature decrease rate is an average value of the rate at which the temperature is decreased to 40° C. from the temperature of the kneaded material upon the end of the kneading process (for example, t2° C. when the screw extruder 11 of FIG. 1 is used).

Specific examples of the cooling method in the cooling process include a method using a mill roll with cold water or brine circulated therein and a method using an insertion-type cooling belt. When the cooling is performed using the above-described method, the cooling rate is determined by the speed of the mill roll, the flow rate of the brine, the supply amount of the kneaded material, the slab thickness at the time of rolling of the kneaded material, and the like. The slab thickness is preferably 1 mm to 3 mm.

Pulverization Process

The kneaded material cooled by the cooling process is pulverized by the pulverization process to form toner particles. In the pulverization process, for example, a mechanical pulverizer, a jet pulverizer or the like is used.

Classification Process

If necessary, the toner particles obtained by the pulverization process may be classified by a classification process in order to obtain toner particles having a volume average particle diameter in a target range. In the classification process, a centrifugal classifier, an inertia-type classifier or the like that has been used in the past is used, and fine powders (toner particles having a particle diameter smaller than the target range) and coarse powders (toner particles having a particle diameter larger than the target range) are removed.

External Addition Process

For charging adjustment, endowment of fluidity, endowment of charge exchangeability, and the like, the above-described inorganic particles typified by particular silica, titanic and aluminum oxide may be added and adhered to the obtained toner particles. This is performed by, for example, a V-blender, a Henschel mixer, a Loedige mixer or the like, and the adhesion is performed in stages.

Sieving Process

If necessary, a sieving process may be provided after the above-described external addition process. Specifically, as a sieving method, for example, a gyro shifter, a vibration sieving machine, a wind-power sieving machine or the like is used. Through sieving, coarse powders of the external additive and the like are removed, and thus the generation of streaks and trickling down contamination are inhibited.

Electrostatic Charge Image Developer

An electrostatic charge image developer of this exemplary embodiment (hereinafter, may be referred to as “developer”) is not particularly limited provided that it contains the above-described toner of this exemplary embodiment. The electrostatic charge image developer may be a single-component developer using a toner alone, or a two-component developer containing a toner and a carrier. When the electrostatic charge image developer is a single-component developer, it may be a toner containing magnetic metallic particles or a nonmagnetic single-component toner containing no magnetic metallic particles.

The carrier is not particularly limited as long as it is a known carrier, and an iron powder-based carrier, a ferrite-based carrier, a surface-coated ferrite carrier or the like is used. In addition, respective surface additive powders may be used after being subjected to a desired surface treatment.

Specific examples of the carrier include the following resin-coated carriers. Examples of the nucleus particles of the carrier include a common iron powder, ferrite, and magnetite granulated products, and the volume average particle diameter thereof is preferably 30 μM to 200 μm,

Examples of the coating resin for the resin-coated carrier include homopolymers of styrenes such as styrene, parachlorostyrene, and α-methylstyrene; α-methylene fatty acid monocarboxylic acids such as methyl acrylate, ethyl acrylate, n-propyl acrylate, lauryl acrylate, 2-ethylhexyl acrylate, methyl methacrylate, n—propyl methacrylate, lauryl methacrylate, and 2-ethylhexyl methacrylate; nitrogen-containing acryls such as dimethylaminoethyl methacrylate; vinyl nitriles such as acrylonitrile and methacrylonitrile; vinyl pyridines such as 2-vinylpyridine and 4-vinylpyridine; vinyl ethers such as vinyl methyl ether and vinyl isobutyl ether; vinyl ketones such as vinyl methyl ketone, vinyl ethyl ketone, and vinyl isopropenyl ketone; olefins such as ethylene and propylene; and fluorine-containing vinyl-based monomers such as vinylidene fluoride, tetrafluoroethylene, and hexafluoroethylene, or copolymers composed of two or more types of monomers, silicone resins including methyl silicone and methylphenyl silicone, polyesters containing bisphenol, glycol, etc., epoxy resins, polyurethane resins, polyamide resins, cellulose resins, polyether resins, and polycarbonate resins. These resins may be used singly or in combination of two or more types. The coating amount of the coating resin is preferably about 0.1 parts by weight to 10 parts by weight with respect to 100 parts by weight of the nucleus particles, and more preferably 0.5 parts by weight to 3.0 parts by weight.

The carrier is manufactured using, for example, a heating kneader, a heating Henschel mixer, a UM mixer, or the like. Depending on the amount of the coating resin, a heating fluidized bed, a heating kiln or the like is used.

Since, even when a thick coating layer is formed, excellent resistance controllability is obtained and excellent image quality and image quality maintainability are thus obtained, it is more preferable to use a carrier that is formed by coating ferrite particles as nuclei with a resin in which carbon black as an electroconductive agent and/or melamine beads as a charge control agent are dispersed in methyl acrylate or ethyl acrylate and styrene.

The mixing ratio of the toner and the carrier in the developer is not particularly limited and is selected in accordance with the purpose.

Image Forming Apparatus

Next, an image forming apparatus using the transparent electrostatic charge image developing toner of this exemplary embodiment will be described.

An image forming apparatus of this exemplary embodiment has an image holding member, a charging unit that charges the image holding member, an exposure unit that exposes a charged image holding member to form an electrostatic latent image on a surface of the image holding member, a developing unit that develops the electrostatic latent image with a developer including a toner to form a toner image, a transfer unit that transfers the toner image onto a surface of a transfer medium from the image holding member, and a fixing unit that fixes the toner image transferred onto the surface of the transfer medium, and the developer is the transparent electrostatic charge image developing toner of this exemplary embodiment, or the electrostatic charge image developer of this exemplary embodiment.

In addition, the image forming apparatus has a cleaning unit (toner removing unit) that scrubs the image holding member with a cleaning member to remove the residual components left after transfer, and uses the electrostatic charge image developer of this exemplary embodiment as the developer.

In the image forming apparatus, for example, a part including the developing unit may be provided to have a cartridge structure (process cartridge) that is detachable from an image forming apparatus body. As the process cartridge, a process cartridge of this exemplary embodiment, that is provided with at least a developer holding member and accommodates the electrostatic charge image developer of this exemplary embodiment, is preferably used.

Hereinafter, an example of the image forming apparatus of this exemplary embodiment will be described. However, the invention is not limited thereto. Major parts shown in the drawing will be described, and descriptions of other parts will be omitted.

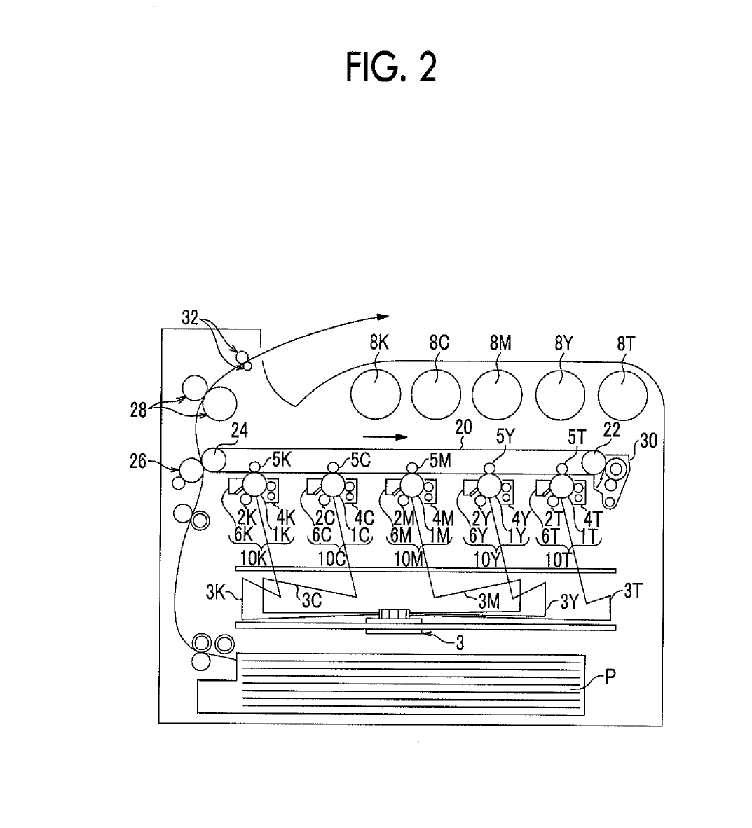

FIG. 2 is a schematic diagram showing the configuration of a 5-drum tandem full-color image forming apparatus. The image forming apparatus shown in FIG. 2 is provided with first to fifth electrophotographic image forming units 10T, 10Y, 10M, 10C, and 10K, (image forming units) that output a transparent (colorless) (T) image, a yellow (Y) image, a magenta (M) image, a cyan (C) image, and a black (K) image, respectively, based on color-separated image data. These image forming units (hereinafter, simply referred to as “units”) 10T, 10Y, 10M, 10C, and 10K are separated from each other and arranged side by side in a horizontal direction. The units 10T, 10Y, 10M, 10C and 10K each may be a process cartridge that is detachably mounted on the image forming apparatus body.

An intermediate transfer belt 20 as an intermediate transfer medium is disposed above the units 10T, 10Y, 10M, 10C, and 10K in the drawing to extend via the units. The intermediate transfer belt 20 is wound on a driving roller 22 and a support roller 24 contacting the inner surface of the intermediate transfer belt 20, which are separated from each other on the left and right sides in the drawing, and travels in the direction toward the fifth unit 10K from the first unit 10T. The support roller 24 is impelled in a direction away from the driving roller 22 by a spring or the like (not shown), and a tension is given to the intermediate transfer belt 20 wound on both of the rollers. In addition, an intermediate transfer medium cleaning device 30 is provided opposed to the driving roller 22 on a surface of the intermediate transfer belt 20 on the image holding member side.

Developing devices (developing units) 4T, 4Y, 4M, 4C, and 4K of the units 10T, 10Y, 10M, 10C and 10K are supplied with five toners, that is, a transparent toner, a yellow toner, a magenta toner, a cyan toner, and a black toner accommodated in toner cartridges 8T, 8Y, 8M, 8C and 8K, respectively.

The above-described first to fifth units 10T, 10Y, 10M, 10C, and 10K have the same configuration. Accordingly, only the first unit 10T that is disposed on the upstream side in the traveling direction of the intermediate transfer belt to form a transparent image will be representatively described. The same portions as in the first unit 10T will be denoted by the reference numerals with yellow (Y), magenta (M), cyan (C), and black (K) added instead of transparent (T), and descriptions of the second to fifth units 10Y, 10M, 10C, and 10K will be omitted.

The first unit 10T has a photoreceptor 1T acting as an image holding member. Around the photoreceptor 1T, a charging roller 2T that charges a surface of the photoreceptor 1T, an exposure device 3 that exposes the charged surface with laser beams 3T based on a color-separated image signal to form an electrostatic latent image, a developing device (developing unit) 4T that supplies a charged toner to the electrostatic latent image to develop the electrostatic latent image, a primary transfer roller (primary transfer unit) 5T that transfers the developed toner image onto the intermediate transfer belt 20, and a photoreceptor cleaning device (cleaning unit) 6T that removes the toner remaining on the surface of the photoreceptor 1T after primary transfer, are arranged in sequence.

The primary transfer roller 5T is disposed inside the intermediate transfer belt 20 to be provided at a position opposed to the photoreceptor 1T. Furthermore, bias supplies (not shown) that apply a primary transfer bias are connected to the primary transfer rollers 5T, 5Y, 5M, 5C, and 5K, respectively. The bias supplies change the transfer bias that is applied to each primary transfer roller under the control of a controller (not shown).

Hereinafter, the operation of forming a transparent image in the first unit 10T will be described. First, before the operation, the surface of the photoreceptor 1T is charged to a potential of about −600 V to −800 V by the charging roller 2T.

The photoreceptor 1T is formed by stacking a photosensitive layer on a conductive base (volume resistivity at 20° C.: 1×10⁻⁶ cm or less). This photosensitive layer typically has high resistance (resistance that is approximately the same as the resistance of a general resin), but has a property that, when laser beams 3T are applied thereto, the specific resistance of a part irradiated with the laser beams changes. Accordingly, the laser beams 3T are output to the surface of the charged photoreceptor 1T via the exposure device 3 in accordance with image data for transparency sent from the controller (not shown). The laser beams 3T are applied to the photosensitive layer on the surface of the photoreceptor 1T, whereby an electrostatic latent image of a transparent print pattern is formed on the surface of the photoreceptor 1T.

The electrostatic latent image is an image that is formed on the surface of the photoreceptor 1T by charging, and is a so-called negative latent image, that is formed by applying the laser beams 3T to the photosensitive layer so that the specific resistance of the irradiated portion is lowered to cause charges to flow on the surface of the photoreceptor 1T, while charges stay on a part to which the laser beams 3T are not applied.

The electrostatic latent image that is formed in this manner on the photoreceptor 1T is rotated up to a development position with the travelling of the photoreceptor 1T. The electrostatic latent image on the photoreceptor 1T is developed at the development position by the developing device 4T.

In the developing device 4T, a transparent toner of this exemplary embodiment is accommodated. The transparent toner is frictionally charged by being stirred in the developing device 4T to have a charge with the same polarity (negative polarity) as the charge that is on the photoreceptor 1T, and is thus held on the developer roll (developer holding member). By allowing the surface of the photoreceptor 1T to pass through the developing device 4T, the transparent toner is electrostatically adhered to a latent image part of which change is removed on the surface of the photoreceptor 1T, whereby the latent image is developed with the transparent toner. Next, the photoreceptor 1T having a transparent toner image formed thereon travels continuously and the developed toner image on the photoreceptor 1T is transported to a primary transfer position.

When the transparent toner image on the photoreceptor 1T is transported to the primary transfer position, a primary transfer bias is applied to the primary transfer roller 5T, an electrostatic force from the photoreceptor 1T toward the primary transfer roller 5T acts on the toner image, and the toner image on the photoreceptor 1T is transferred onto the intermediate transfer belt 20. The transfer bias applied at this time has the opposite polarity (+) of the toner polarity (−), and is controlled to, for example, about +10 μA in the first unit 10T by the controller (not shown).

On the other hand, the toner remaining on the photoreceptor 1T is removed and collected by the photoreceptor cleaning device 6T.

The primary transfer biases that are applied to the primary transfer rollers 5Y, 5M, 5C, and 5K of the second unit 10Y and the subsequent units are also controlled in the same manner as in the case of the first unit.

In this manner, the intermediate transfer belt 20 onto which the transparent toner image is transferred by the first unit 10T is sequentially transported through the second to fifth units 10Y, 10M, 10C, and 10K, and the toner images of respective colors are multiply-transferred in a superimposed manner.

The intermediate transfer belt 20 onto which the five color toner images have been multiply-transferred through the first to fifth units reaches a secondary transfer portion which includes the intermediate transfer belt 20, the support roller 24 contacting the inner surface of the intermediate transfer belt 20, and a secondary transfer roller (secondary transfer unit) 26 disposed on the image holding surface side of the intermediate transfer belt 20. Meanwhile, a recording sheet (transfer medium) P is supplied to a gap between the secondary transfer roller 26 and the intermediate transfer belt 20, which are pressed against each other, via a supply mechanism, and a secondary transfer bias is applied to the support roller 24.

The transfer bias applied at this time has the same polarity (−) as the toner polarity (−), and an electrostatic force from the intermediate transfer belt 20 toward the recording sheet P acts on the toner image, whereby the toner image on the intermediate transfer belt 20 is transferred onto the recording sheet P. In this case, the secondary transfer bias is determined depending on the resistance detected by a resistance detector (not shown) that detects the resistance of the secondary transfer portion, and is voltage-controlled.

Thereafter, the recording sheet P is fed to the fixing device (fixing unit) 28, the toner image is heated, and the color-superimposed toner image is melted and fixed onto the recording sheet P. The recording sheet P on which the fixing of the color image is completed is transported toward the discharge portion, and a series of the color image forming operations ends.

The image forming apparatus exemplified as above has a configuration in which the toner image is transferred onto the recording sheet P via the intermediate transfer belt 20. However, the invention is not limited to this configuration, and may have a structure in which the toner image may be transferred directly onto the recording sheet from the photoreceptor.

The transparent toner image is preferably formed as a uniform layer (solid image) on the entire surface of the printing surface including the color image, but this exemplary embodiment is not limited thereto. The transparent toner image may be formed only on the color image, or particularly, only on a part that is required to have gloss.

Process Cartridge and Toner Cartridge

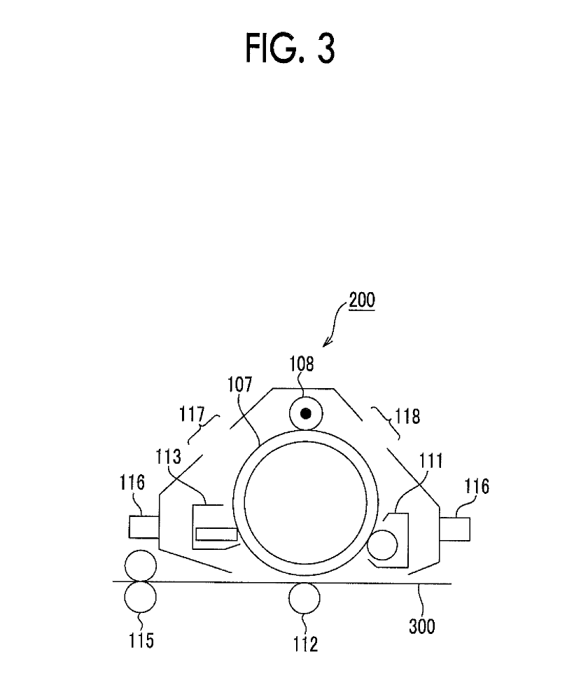

FIG. 3 is a schematic diagram showing the configuration of a preferable example of a process cartridge that accommodates the electrostatic charge image developer of this exemplary embodiment. A process cartridge 200 has, in addition to a photoreceptor 107, a charging roller 108, a developing device 111 provided with a developer holding member 111A, a photoreceptor cleaning device (cleaning unit) 113, an opening 118 for exposure, and an opening 117 for charge-removing exposure, and they are combined and integrated using an attachment rail 116.

The process cartridge 200 is detachably mounted on an image forming apparatus body including a transfer device 112, a fixing device 115, and other constituent parts (not shown), and constitutes, together with the image forming apparatus body, an image forming apparatus that forms an image on a recording sheet 300.

The process cartridge shown in FIG. 3 includes the charging roller 108, the developing device 111, the cleaning device (cleaning unit) 113, the opening 118 for exposure, and the opening 117 for charge-removing exposure, but these devices may be selectively combined. The process cartridge of this exemplary embodiment may include at least the developing device 111 provided with the developer holding member 111A and may include at least one selected from the group consisting of the photoreceptor 107, the charging device 108, the cleaning device (cleaning unit) 113, the opening 118 for exposure, and the opening 117 for charge-removing exposure.

Next, a toner cartridge of this exemplary embodiment will be described. The toner cartridge is detachably mounted on an image forming apparatus, and at least in the toner cartridge that stores a toner to be supplied to a developing unit provided in the image forming apparatus, the toner is the above-described toner of this exemplary embodiment. It is sufficient that the toner cartridge of this exemplary embodiment accommodates at least a toner, and depending on the mechanism of the image forming apparatus, may accommodate, for example, a developer.

Accordingly, in an image forming apparatus having a configuration in which a toner cartridge is detachably mounted, a toner cartridge that stores the toner of this exemplary embodiment is used to easily supply the toner of this exemplary embodiment to a developing device.

The image forming apparatus shown in FIG. 2 is an image forming apparatus that has a configuration in which the toner cartridges 8T, 8Y, 8M, 8C, and 8K are detachably mounted. The developing devices 4T, 4Y, 4M, 4C, and 4K are connected to the toner cartridges corresponding to the respective developing devices (colors) via toner supply tubes (not shown). In addition, when the toner stored in the toner cartridge runs low, the toner cartridge may be replaced.

Image Forming Method

Next, an image forming method using the toner of this exemplary embodiment will be described. The toner of this exemplary embodiment is used in a known image forming method using an electrophotographic system. Specifically, the toner is used in an image forming method having the following processes.

That is, a preferable image forming method includes: a latent image forming process of forming an electrostatic latent image on a surface of an image holding member; a developing process of developing the electrostatic latent image formed on the surface of the image holding member with a developer including a toner to form a toner image; a transfer process of transferring the toner image onto a surface of a transfer medium; and a fixing process of fixing the toner image transferred onto the surface of the transfer medium, and uses the electrostatic charge image developing toner of this exemplary embodiment, or the electrostatic charge image developer of this exemplary embodiment as the developer. In addition, in the transfer process, an intermediate transfer medium that mediates the transfer of the toner image onto the transfer medium from the electrostatic latent image holding member may be used.

### EXAMPLES

Hereinafter, this exemplary embodiment will be described in more detail using examples and comparative examples, but is not limited to the examples.

In the following examples, unless specifically noted, “parts” represents “parts by weight” and “%” represents “wt %”.

Measurement Method

Element Analysis

The content of a rare earth element and the content of phosphorus (P) in the toner may be measured by the following method. That is, using a scanning X-ray fluorescence spectrometer (Rigaku zSX Primus II), a disk having a toner amount of 0.130 g is molded, and under the conditions of an X-ray output of 40 mA to 70 mA, a measurement area of 10 mmφ, and a measurement time of 15 minutes, the measurement is performed through a qualitative and quantitative total elemental analysis method. The analysis value of Lα of each element of the data of the measurement is set as an element amount of this exemplary embodiment. When a peak of this and a peak of another element overlap each other, analysis by ICP emission spectrometry or an atomic absorption method is performed to obtain the analysis value.

Method of Measuring Volume Average Particle Diameter of Carrier and Volume Average Particle Diameter of Toner

The volume average particle diameter of a carrier is measured using an electronic microscope (SEM). More specifically, an image is obtained by SEM, and then a particle diameter (maximum length part) r1 is measured for each particle. 100 particle diameters are measured, and then r1 to r100 are expressed in terms of spherical diameter to obtain volumes, and the value corresponding to 50% from the first volume to the one hundredth volume is set as the volume average particle diameter.

The volume average particle diameter of a toner is measured using a Coulter Multisizer II (manufactured by Beckman Coulter, Inc.). ISOTON-II (manufactured by Beckman Coulter, Inc.) is used as an electrolyte.

As a measurement method, first, 0.5 mg to 50 mg of a measurement sample is added to 2 ml of a surfactant as a dispersant, preferably a 5% aqueous solution of sodium alkylbenzene sulfonate. The resultant material is added to 100 ml to 150 ml of the electrolyte. The electrolyte in which the measurement sample is suspended is subjected to a dispersion treatment for about 1 minute by an ultrasonic dispersing machine, and the particle size distribution of particles having a particle diameter of 2.0 μm to 60 μm is measured by the Coulter Multisizer II with the use of an aperture having an aperture diameter of 100 μm. The number of particles to be measured is 50,000.

The measured particle size distribution is accumulated to draw a cumulative distribution from the smallest diameter side for the weight or volume relative to divided particle size ranges (channels), and the particle diameter corresponding to 50% in accumulation is defined as a weight average particle diameter or a volume average particle diameter.

### Synthesis of Complex Compound A

50 parts of an ethanol solution A containing 0.4 parts of acetylacetone and 0.6 parts of triphenylphosphine oxide dissolved therein is nitrogen-substituted, and then heating is started and the temperature is maintained at 80° C. 40 parts of an ethanol solution (solution B) containing 0.2 parts of europium chloride is prepared and added dropwise to the solution A over 20 minutes. While being maintained at 80° C., the system is stirred. After aging for 5 hours, the solvent is removed by distillation under reduced pressure. A powder obtained in this manner is vacuum-dried, thereby obtaining a complex compound A.

### Synthesis of Complex Compounds B to J

Complex compounds B to J are synthesized in the same manner as in the case of the complex compound A, except that the acetylacetone is changed to the following compounds. D represents deuterium.

TABLE 1

| Complex | |
|---|---|
| Compound | Raw Material |
| A | 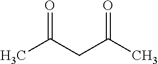 |
| B | 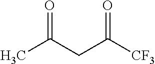 |
| C | 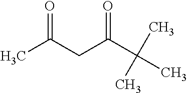 |
| D | 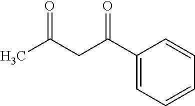 |
| E | 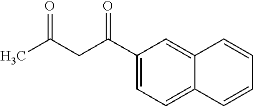 [SMILES: CC(=O)CC(=O)c1ccc2ccccc2c1] |
| F | 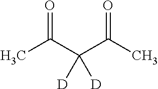 |
| G | 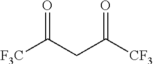 [SMILES: O=C(CC(=O)C(F)(F)F)C(F)(F)F] |
| H | 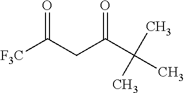 |
| I | 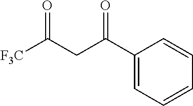 [SMILES: O=C(CC(=O)C(F)(F)F)c1ccccc1] |
| J | 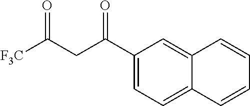 [SMILES: O=C(CC(=O)C(F)(F)F)c1ccc2ccccc2c1] |

### Synthesis of Complex Compound K

A complex compound K is synthesized in the same manner as in the case of the complex compound B, except that the europium chloride used in the synthesis of the complex compound B is changed to terbium chloride.

### Synthesis of Complex Compound L

A complex compound L is synthesized in the same manner as in the case of the complex compound B, except that the europium chloride used in the synthesis of the complex compound B is changed to samarium chloride.

### Synthesis of Complex Compound M

A complex compound M is synthesized in the same manner as in the case of the complex compound B, except that the europium chloride used in the synthesis of the complex compound B is changed to yttrium chloride.

### Synthesis of Complex Compound N

A complex compound N is synthesized in the same manner as in the case of the complex compound A, except that the amount of the triphenylphosphine oxide used is changed to 2.0 parts. The complex compound N uses an excessive amount of a triphenylphosphine oxide.

### Synthesis of Complex Compound O

A complex compound O is synthesized in the same manner as in the case of the complex compound A, except that the amount of the triphenylphosphine oxide used is changed to 2.8 parts. The complex compound O uses a large excessive amount of a triphenylphosphine oxide.

### Synthesis of Complex Compound P

A complex compound P is synthesized in the same manner as in the case of the complex compound A, except that the acetylacetone used in the synthesis of the complex compound

A is changed to 4,4,4-tri fluoro-1-(2-thienyl)-1,3-butanedione.

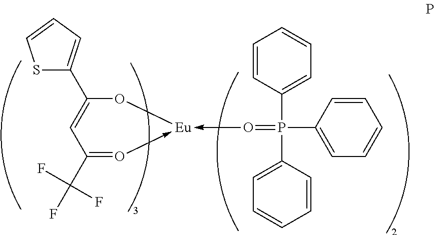

### Preparation of Toner 1

Polyester Resin (polyester resin that is synthesized using a tin catalyst containing propylene oxide 2-mol adduct/ethylene oxide 2-mol adduct of bisphenol A, a terephthalic acid, and a trimellitic acid as major components): 171 parts

Release Agent (Polypropylene; manufactured by Mitsui Chemicals, Inc., Mitsui HI-WAX NP055): 5.0 parts

Complex Compound A: 10.0 parts

The above components are mixed using a Henschel mixer, and then kneading is carried out using a continuous kneader (two-axis extruder) having the screw structure shown in FIG. 1 under the following conditions. The rotation rate of the screw is set to 500 rpm.

Preset Temperature of Feeding Portion (Blocks 12A and 12B): 20° C.

Preset Kneading Temperature of Kneading Portion 1 (Blocks 12C to 12E): 100° C.

Preset Kneading Temperature of Kneading Portion 2 (Blocks 12F to 12J): 110° C.

Added Amount of Aqueous Medium (distilled water) (with respect to 100 parts of Raw Material Supply Amount): 1.5 parts

At this time, the temperature of the kneaded material in the discharge port (discharge port 18) is 120° C.

The kneaded material is rapidly cooled using a mill roll in which brine at −5° C. is circulated and a slab insertion-type cooling belt for cooling with cold water at 2° C. After cooling, crushing is performed using a hammer mill. The rapid cooling rate is confirmed by changing the speed of the cooling belt and the average temperature decrease rate is 10° C./sec.

Thereafter, pulverization is performed using a pulverizer with a built-in coarse powder classifier (AFG 400) to obtain pulverized particles. Then, classification is performed using an inertia-type classifier to remove fine powders and coarse powders, and thus toner particles 1 having a volume average particle diameter of 6.2 μm are obtained.

1.5 parts of a titanium compound (number average primary particle diameter: 43 nm) that is obtained by treating 100 parts of a metatitanic acid with 40 parts of isobutyl trimethoxysilane and 1.2 parts of spherical silica that is treated with hexamethyldisilazane of 130 nm are added to the obtained toner particles and followed by mixing for 10 minutes by a Henschel mixer (external addition blending). Then, by a wind-power sieving machine (hi-bolter), 45 μm-sieving is performed to obtain Toner 1 having a volume average particle diameter of 6.2 μm. The results are shown in Table 2.

### Preparation of Toners 2 to 13

Toner particles 2 to 13 are obtained in the same manner as in the case of the toner 1, except that the complex compound A used in the preparation of the toner 1 is changed to the complex compounds B to M as shown in Table 2. The external addition and sieving processes are performed in the same manner as in the case of the toner particles 1, thereby obtaining Toner 2 to Toner 13. The results are shown in Table 2.

### Preparation of Toner 14

Toner particles 14 are obtained in the same manner as in the case of the toner 1, except that the amount of the complex compound A used in the preparation of the toner 1 is changed to 5.0 parts. Toner 14 having a volume average particle diameter of 6.0 μm is obtained in the same manner as in the case of the toner particles 1. The results are shown in Table 2.

### Preparation of Toner 15

Toner particles 15 are obtained in the same manner as in the case of the toner 1, except that the amount of the complex compound A used in the preparation of the toner 1 is changed to 2.0 parts. Toner 15 having a volume average particle diameter of 5.8 μm is obtained in the same manner as in the case of the toner particles 1. The results are shown in Table 2.

### Preparation of Toner 16

Toner particles 16 are obtained in the same manner as in the case of the toner 1, except that the amount of the complex compound A used in the preparation of the toner 1 is changed to 30 parts. Toner 16 having a volume average particle diameter of 5.4 μm is obtained in the same manner as in the case of the toner particles 1. The results are shown in Table 2.

### Preparation of Toner 17

Toner particles 17 are obtained in the same manner as in the case of the toner 1, except that the amount of the complex compound A used in the preparation of the toner 1 is changed to 50 parts. Toner 17 having a volume average particle diameter of 5.9 μm is obtained in the same manner as in the case of the toner particles 1. The results are shown in Table 2.

### Preparation of Toner 18

Toner particles 18 are obtained in the same manner as in the case of the toner 1, except that the complex compound A used in the preparation of the toner 1 is changed to the complex compound N. Toner 18 having a volume average particle diameter of 6.4 μm is obtained by performing the external addition and sieving processes in the same manner as in the case of the toner particles 1. The results are shown in Table 2.

### Preparation of Toner 19

Toner particles 19 are obtained in the same manner as in the case of the toner 1, except that the complex compound A used in the preparation of the toner 1 is changed to the complex compound O. Toner 19 having a volume average particle diameter of 5.7 μm is obtained by performing the external addition and sieving processes in the same manner as in the case of the toner particles 1. The results are shown in Table 2.

### Preparation of Toner 20

Toner particles 20 are obtained in the same manner as in the case of the toner 1, except that the coarse powders are collected by the inertia-type classifier used in the preparation of the toner 1. Toner 20 having a volume average particle diameter of 21.6 μm is obtained by performing the external addition and sieving processes in the same manner as in the case of the toner particles 1. The results are shown in Table 2.

### Preparation of Toner 21

Toner particles 21 are obtained in the same manner as in the case of the toner 1, except that the fine powders are collected by the inertia-type classifier used in the preparation of the toner 1. Toner 21 having a volume average particle diameter of 2.1 μm is obtained by performing the external addition and sieving processes in the same manner as in the case of the toner particles 1. The results are shown in Table 2.

### Preparation of Toner 22

### Preparation of Styrene Acrylic Resin (Styrene-Butyl Acrylate Copolymer)

90 parts of styrene and 10 parts of butyl acrylate are polymerized under cumene reflux (146° C. to 156° C., in the presence of 0.01 parts of Sn) in a reactor to synthesize a styrene acrylic resin that is a styrene-butyl acrylate copolymer.

### Preparation of Toner 22

Toner particles 22 are obtained in the same manner as in the case of the toner 1, except that the polyester resin used in the preparation of the toner 1 is changed to the above-described styrene acrylic resin. Toner 22 having a volume average particle diameter of 7.2 μm is obtained by performing the external addition and sieving processes in the same manner as in the case of the toner particles 1. The results are shown in Table 2.

### Preparation of Toner 23

### Preparation of Polyester Resin Particle Dispersion (1)

100 parts of a polyester resin (polyester resin that is synthesized using a tin catalyst containing propylene oxide 2-mol adduct/ethylene oxide 2-mol adduct of bisphenol A, a terephthalic acid, and a trimellitic acid as major components), 50 parts of methyl ethyl ketone, 30 parts of isopropyl alcohol, and 5 parts of a 10% ammonia aqueous solution are put into a separable flask and sufficiently mixed to be dissolved. Then, while the mixture is heated at 40° C. and stirred, ion exchange water is added dropwise at a liquid sending rate of 8 g/min using a liquid sending pump.

The solution in the flask is made uniformly cloudy, and then the liquid sending rate is raised to 25 g/min to cause phase inversion, and the dropping is stopped when the liquid sending amount is 135 parts. Thereafter, the solvent is removed under reduced pressure, thereby obtaining a polyester resin particle dispersion (1). The volume average particle diameter of the obtained polyester resin particles is 158 nm, and the solid content concentration of the resin particles is 39%.

### Preparation of Release Agent Dispersion (1)

Ester Wax WEP 5 (manufactured by NOF Corporation): 500 parts

Anionic Surfactant (Daiichi Kogyo Seiyaku Co., Ltd: NEOGEN RK): 50 parts

Ion Exchange Water: 2,000 parts The above components are heated to 110° C. and dispersed using a homogenizer (manufactured by IKA-Werke Gmbh & Co. KG: Ultra Turrax T50). Then, a dispersion treatment is performed by a Manton-Gaulin high-pressure homogenizer (manufactured by Gaulin Corporation) to prepare a release agent dispersion (1) (release agent concentration: 23%) in which a release agent having an average particle diameter of 0.24 μm is dispersed.

### Preparation of Toner 23

Polyester Resin Particle Dispersion (1): 280 parts

Complex Compound A: 20 parts

Anionic Surfactant (dowfax 2A1, 20% aqueous solution): 8 parts

Release Agent Dispersion (1): 60 parts The polyester resin particle dispersion (1) and the anionic surfactant among the above raw materials, and 340 parts of ion exchange water are put into a polymerization tank provided with a pH meter, a stirring blade, and a thermometer, and are stirred for 15 minutes at 150 rpm.

Next, the release agent dispersion (1) is added and mixed, and then a 0.3 M-nitric acid aqueous solution is added to the raw material mixture to obtain a raw material dispersion prepared to have a pH of 4.2.

While a shear force is applied to the raw material dispersion at 3,000 rpm using an Ultra Turrax, 27 parts of a nitric acid aqueous solution containing 1% of aluminum sulfate are added dropwise as a flocculant. During the dropping of the flocculant, the viscosity of the raw material dispersion rapidly increases. Accordingly, at the time when the viscosity increases, the drop rate is reduced to uniformly distribute the flocculant. When the dropping of the flocculant ends, the rotation rate is further raised to 5,000 rpm and the stirring is performed for 5 minutes.

While being warmed to 30° C. using a mantle heater, the raw material dispersion is stirred at 350 rpm to 600 rpm. After stirring for 30 minutes, stable formation of a primary particle diameter is confirmed using a Coulter Counter [TA-II] (aperture diameter: 50 μm; manufactured by Beckman Coulter, Inc.), and then the temperature is raised to 42° C. at 0.1° C./min to grow aggregated particles. While confirming the growth of aggregated particles as necessary using the Coulter Counter, the aggregation temperature and rotation rate of stirring are appropriately adjusted by the aggregation rate.

Meanwhile, in order to form a coating layer on the surfaces of the aggregated particles, 30 parts of ion exchange water and 4.2 parts of an anionic surfactant (dowfax 2A1, 20% aqueous solution) are added to 110 parts of a polyester resin particle dispersion (1) and mixed to provide a solution prepared to have a pH of 3.3 in advance.

When the aggregated particles are grown to have a volume average particle diameter of 5.4 μm, a solution for forming a coating layer prepared in advance is added, and then the resultant is held for 10 minutes while being stirred. Thereafter, in order to stop the growth of the aggregated particles having a coating layer formed thereon, 1.5 pph of an ethylenediaminetetraacetic acid (EDTA) is added with respect to the total amount of the dispersion put into the polymerization tank, and then 1 mol/L of a sodium hydroxide aqueous solution is added to control the pH of the raw material dispersion to 7.5.

Next, in order to coalesce the aggregated particles together, the temperature is raised to 85° C. at a temperature increase rate of 1° C./min while the pH is adjusted to 7.5. The pH is still adjusted to 7.5 to advance the coalescence even after the temperature reaches 85° C., and after confirming the coalescence of the aggregated particles by an optical microscope, ice water is injected for rapid cooling at a temperature decrease rate of 10° C./min in order to stop the growth of the particle diameter.

Thereafter, for the purpose of washing the obtained particles, sieving is performed once with a 15 μm-opening mesh. Next, ion exchange water (30° C.) is added in an amount approximately 10 times the solid content and the resultant is stirred for 20 minutes, and is then filtered. Furthermore, the solid content remaining on the filter paper is dispersed in a slurry, repeatedly washed four times with ion exchange water at 30° C., and then dried to obtain toner particles 23 having a volume average particle diameter of 6.5 μm.

Thereafter, 1 part of gas phase method silica (manufactured by Nippon Aerosil Co., Ltd., 8972, number average primary particle diameter: 43 nm) is mixed with 100 parts of the obtained toner particles by a Henschel mixer (for 10 minutes at 25 m/s) for external addition, thereby obtaining Toner 23 having a volume average particle diameter of 6.5 μm. The results are shown in Table 2.

### Preparation of Toner 24

Toner particles 24 for comparison are obtained in the same manner as in the case of the toner 1, except that the complex compound A used in the preparation of the toner 1 is not used. Toner 24 for comparison having a volume average particle diameter of 6.8 μm is obtained by performing the external addition and sieving processes in the same manner as in the case of the toner particles 1. The results are shown in Table 2.

### Preparation of Toner 25

Toner particles 25 for comparison are obtained in the same manner as in the case of the toner 1, except that the complex compound A used in the preparation of the toner 1 is changed to the complex compound P. Toner 25 for comparison having a volume average particle diameter of 5.4 μm is obtained by performing the external addition and sieving processes in the same manner as in the case of the toner particles 1. The results are shown in Table 2.

Evaluation Methods

Preparation of Developer

Preparation of Developers 1 to 23 and Developers 24 and 25 for Comparison

100 parts of a carrier (1) and 7 parts of an external additive-added toner are mixed for 20 min at 40 rpm by a V-blender to prepare Developers 1 to 23 and Developers 24 and 25 for comparison.

Gloss Evaluation

Regarding the gloss, solid images having a size of 3 cm×4 cm are printed using the obtained Developers 1 to 23 and Developers 24 and 25 for comparison under a high-temperature and high-humidity environment (28° C., 90% RH) by a DocuCentre Color 400CP manufactured by Fuji Xerox Co., Ltd., and after printing of 10,000 images, a surface state of the image patch is visually confirmed. The criteria for judgment are as follows.

A: The surface is uniform and gloss may be confirmed (unevenness is not confirmed even when being observed with a magnifying glass).

B: The surface is uniform and gloss may be confirmed (unevenness is confirmed in places when being observed with a magnifying glass).

C: Unevenness may be confirmed in places on the surface even when observed without a magnifying glass and the gloss is inhibited.

D: Image unevenness is clearly confirmed and the gloss is low.

The results are shown in Table 2.

Charge Amount Evaluation

Regarding the charging stability, solid images having a size of 3 cm×4 cm are printed using the obtained Developers 1 to 23 and Developers 24 and 25 for comparison under a high-temperature and high-humidity environment (28° C., 90% RH) by a DocuCentre Color 400CP manufactured by Fuji Xerox Co., Ltd., and an absolute value of the charge amount on a magnetic roll is measured by a blow off tribo measuring device (manufactured by Toshiba Chemical Corporation) at an initial time of the image formation and after printing of 10,000 images. A degree of the change thereof is used for judgment. The criteria for judgment are as follows.

A: A change in charge amount is less than 3 μC/g.

B: A change in charge amount is 3 μC/g to less than 7 μC/g.

C: A change in charge amount is 7 μC/g to less than 10 μC/g.

D: A change in charging amount is 10 μC/g or greater.

The results are shown in Table 2.

Transfer Belt Contamination Evaluation

In a transfer belt contamination evaluation, 10,000 solid images having a size of 3 cm×4 cm are printed using the obtained Developers 1 to 23 and Developers 24 and 25 for comparison under a high-temperature and high-humidity environment (28° C., 90% RH) by a modified DocuCentre Color 400CP manufactured by Fuji Xerox Co., Ltd. Then, a timer is installed to stop the machine at a time immediately after transfer of the developer from the transfer belt to a sheet, and the same image is printed. After confirming that the machine has been stopped, the transfer belt is subjected to a tape transfer using a transparent tape. The tape is attached to a black sheet and visually confirmed.

The criteria for evaluation are as follows.

A: The white toner is almost not confirmed even when being observed with a magnifying glass.

B: The white toner is almost not visually confirmed.

C: The white toner may be visually confirmed.

D: The white toner may be easily confirmed and there is a problem in practical use.

The results are shown in the following Table 2.

TABLE 2

| | | | | | | | Fluorescent |
|---|---|---|---|---|---|---|---|
| | | | | | | | X-ray |
| | | Complex | Central | | | | Eu Amount |
| Developer | Toner | Compound | Metal | R¹ | R² | R³ | A₁ (wt %) |
| 1 | 1 | A | Eu | Methyl Group | Hydrogen | Methyl Group | 0.51 |
| 2 | 2 | B | Eu | Methyl Group | Hydrogen | Trifluoromethyl Group | 0.48 |
| 3 | 3 | C | Eu | Methyl Group | Hydrogen | t-Butyl Group | 0.57 |
| 4 | 4 | D | Eu | Methyl Group | Hydrogen | Phenyl Group | 0.42 |
| 5 | 5 | E | Eu | Methyl Group | Hydrogen | Naphthyl Group | 0.52 |
| 6 | 6 | F | Eu | Methyl Group | Deuterium | Methyl Group | 0.5 |
| 7 | 7 | G | Eu | Trifluoromethyl Group | Hydrogen | Trifluoromethyl Group | 0.46 |
| 8 | 8 | H | Eu | Trifluoromethyl Group | Hydrogen | t-Butyl Group | 0.46 |
| 9 | 9 | I | Eu | Trifluoromethyl Group | Hydrogen | Phenyl Group | 0.5 |
| 10 | 10 | J | Eu | Trifluoromethyl Group | Hydrogen | Naphthyl Group | 0.54 |
| 11 | 11 | K | Tb | Methyl Group | Hydrogen | Trifluoromethyl Group | 0.58 |
| 12 | 12 | L | Sm | Methyl Group | Hydrogen | Trifluoromethyl Group | 0.5 |
| 13 | 13 | M | Y | Methyl Group | Hydrogen | Trifluoromethyl Group | 0.39 |
| 14 | 14 | A | Eu | Methyl Group | Hydrogen | Methyl Group | 0.19 |
| 15 | 15 | A | Eu | Methyl Group | Hydrogen | Methyl Group | 0.09 |
| 16 | 16 | A | Eu | Methyl Group | Hydrogen | Methyl Group | 1.63 |
| 17 | 17 | A | Eu | Methyl Group | Hydrogen | Methyl Group | 2.83 |
| 18 | 18 | N | Eu | Methyl Group | Hydrogen | Methyl Group | 0.63 |
| 19 | 19 | O | Eu | Methyl Group | Hydrogen | Methyl Group | 0.55 |
| 20 | 20 | A | Eu | Methyl Group | Hydrogen | Methyl Group | 0.51 |
| 21 | 21 | A | Eu | Methyl Group | Hydrogen | Methyl Group | 0.44 |
| 22 | 22 | A | Eu | Methyl Group | Hydrogen | Methyl Group | 0.57 |
| 23 | 23 | A | Eu | Methyl Group | Hydrogen | Methyl Group | 0.48 |
| 24 | 24 | — | — | — | — | — | — |
| 25 | 25 | P | Eu | Trifluoromethyl Group | Hydrogen | 2-Thienyl Group | 0.52 |

| | Fluorescent | | Toner | | | | |
|---|---|---|---|---|---|---|---|
| | X-ray | | Particle | | | | |
| | P Amount | | Diameter | | | Charge | Transfer Belt |
| Developer | A₂ (wt %) | A₂/A₁ | (μm) | Preparation Method | Gloss | Amount | Contamination |
| 1 | 0.23 | 0.5 | 6.2 | Kneading Pulverization | A | A | A |
| 2 | 0.31 | 0.6 | 5.7 | Kneading Pulverization | A | A | A |
| 3 | 0.35 | 0.6 | 5.8 | Kneading Pulverization | A | A | A |
| 4 | 0.27 | 0.6 | 6.2 | Kneading Pulverization | A | A | A |
| 5 | 0.2 | 0.4 | 6.4 | Kneading Pulverization | A | A | A |
| 6 | 0.18 | 0.4 | 5.5 | Kneading Pulverization | A | A | A |
| 7 | 0.29 | 0.6 | 5.7 | Kneading Pulverization | A | A | A |
| 8 | 0.32 | 0.7 | 5.9 | Kneading Pulverization | A | A | A |
| 9 | 0.26 | 0.5 | 5.7 | Kneading Pulverization | A | A | A |
| 10 | 0.28 | 0.5 | 6.1 | Kneading Pulverization | A | A | A |
| 11 | 0.29 | 0.5 | 5.8 | Kneading Pulverization | A | B | A |
| 12 | 0.32 | 0.6 | 5.6 | Kneading Pulverization | A | B | A |
| 13 | 0.24 | 0.6 | 6.1 | Kneading Pulverization | A | B | A |
| 14 | 0.08 | 0.4 | 6.0 | Kneading Pulverization | B | A | B |
| 15 | 0.04 | 0.4 | 5.8 | Kneading Pulverization | C | A | B |
| 16 | 0.82 | 0.5 | 5.4 | Kneading Pulverization | B | A | B |
| 17 | 1.72 | 0.6 | 5.9 | Kneading Pulverization | C | A | B |
| 18 | 1.05 | 1.7 | 6.4 | Kneading Pulverization | A | C | B |
| 19 | 1.29 | 2.3 | 5.7 | Kneading Pulverization | A | C | B |
| 20 | 0.21 | 0.4 | 21.6 | Kneading Pulverization | C | A | B |
| 21 | 0.28 | 0.6 | 2.1 | Kneading Pulverization | B | A | C |
| 22 | 0.3 | 0.5 | 7.2 | Kneading Pulverization | A | B | A |
| 23 | 0.23 | 0.5 | 6.5 | Aggregation | A | A | B |
| 24 | — | — | 6.8 | Kneading Pulverization | D | D | D |
| 25 | 0.34 | 0.7 | 5.4 | Kneading Pulverization | D | C | D |

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

1. A transparent electrostatic charge image developing toner comprising:
a binder resin; and
a compound represented by the following Formula (1): 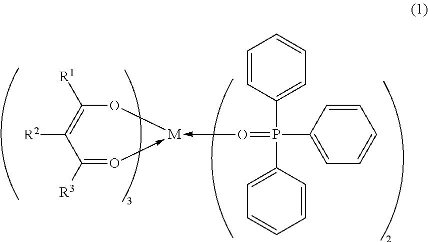
wherein in Formula (1), R¹ represents a methyl group or a trifluoromethyl group; R² represents a hydrogen atom; R³ represents a methyl group, a trifluoromethyl group, a t-butyl group, a phenyl group, or a naphthyl group; and M represents a rare earth element.

2. The transparent electrostatic charge image developing toner according to claim 1,
wherein in Formula (1), M represents yttrium (Y), europium (Eu), terbium (Tb), or samarium (Sm).

3. The transparent electrostatic charge image developing toner according to claim 1,
wherein in Formula (1), M represents europium (Eu), terbium (Tb), or samarium (Sm).

4. The transparent electrostatic charge image developing toner according to claim 2,
wherein in Formula (1), M represents europium (Eu), terbium (Tb), or samarium (Sm).

5. The transparent electrostatic charge image developing toner according to claim 1,
wherein in Formula (1), M represents europium (Eu).

6. The transparent electrostatic charge image developing toner according to claim 2,
wherein in Formula (1), M represents europium (Eu).

7. The transparent electrostatic charge image developing toner according to claim 3,
wherein in Formula (1), M represents europium (Eu).

8. The transparent electrostatic charge image developing toner according to claim 4,
wherein in Formula (1), M represents europium (Eu).

9. The transparent electrostatic charge image developing toner according to claim 1,
wherein a content of the rare earth element in the toner measured by fluorescent X-ray analysis is 0.2% by weight to 1.5% by weight.

10. The transparent electrostatic charge image developing toner according to claim 2,
wherein a content of the rare earth element in the toner measured by fluorescent X-ray analysis is 0.2% by weight to 1.5% by weight.

11. The transparent electrostatic charge image developing toner according to claim 3,
wherein a content of the rare earth element in the toner measured by fluorescent X-ray analysis is 0.2% by weight to 1.5% by weight.

12. The transparent electrostatic charge image developing toner according to claim 4,
wherein a content of the rare earth element in the toner measured by fluorescent X-ray analysis is 0.2% by weight to 1.5% by weight.

13. The transparent electrostatic charge image developing toner according to claim 5,
wherein a content of the rare earth element in the toner measured by fluorescent X-ray analysis is 0.2% by weight to 1.5% by weight.

14. The transparent electrostatic charge image developing toner according to claim 1,
wherein when a content of the rare earth element in the toner measured by fluorescent X-ray analysis is represented by A₁% by weight, and a content of phosphorus in the toner is represented by A₂% by weight, A₂/A₁ is 0.2 to 1.5.

15. The transparent electrostatic charge image developing toner according to claim 1,
wherein a volume average particle diameter Dv is 3 μm to 20 μm.

16. A method of manufacturing the transparent electrostatic charge image developing toner according to claim 1, comprising:
kneading a toner forming material containing the binder resin and the compound represented by Formula (1);
cooling a kneaded material formed by the kneading;
pulverizing the kneaded material cooled by the cooling; and
classifying the kneaded material pulverized by the pulverizing.

17. An electrostatic charge image developer comprising:
the transparent electrostatic charge image developing toner according to claim 1; and
a carrier.

18. A toner cartridge that is detachable from an image forming apparatus and accommodates the transparent electrostatic charge image developing toner according to claim 1.

19. An image forming apparatus comprising:
an image holding member;
a charging unit that charges the image holding member;
an exposure unit that exposes a charged image holding member to form an electrostatic latent image on a surface of the image holding member;
a developing unit that develops the electrostatic latent image with a developer including a toner to form a toner image;
a transfer unit that transfers the toner image onto a surface of a transfer medium from the image holding member; and
a fixing unit that fixes the toner image transferred onto the surface of the transfer medium,
wherein the developer is the transparent electrostatic charge image developing toner comprising:
a binder resin; and
a compound represented by the following Formula (1): 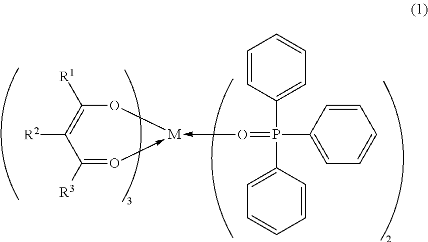
wherein in Formula (1), R¹ represents a methyl group or a trifluoromethyl R² represents a hydrogen atom; R³ represents a methyl group, a trifluoromethyl group, a t-butyl group, a phenyl group, or a naphthyl group; and M represents a rare earth element, or the electrostatic charge image developer according to claim 17.

20. An image forming method comprising:
forming an electrostatic latent image on a surface of an image holding member;
developing the electrostatic latent image formed on the surface of the image holding member with a developer including a toner to form a toner image;
transferring the toner image onto a surface of a transfer medium; and
fixing the toner image transferred onto the surface of the transfer medium,
wherein the transparent electrostatic charge image developing toner comprising:
a binder resin; and
a compound represented by the following Formula (1): 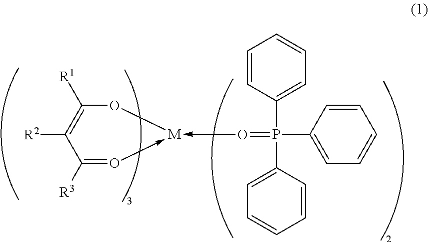
wherein in Formula (1), R1 represents a methyl group or a trifluoromethyl group; R2 represents a hydrogen atom; R3 represents a methyl group, a trifluromethyl group, a t-butyl group, a phenyl group, or a naphthyl group; and M represents a rare earth element, or the electrostatic charge image developer according to claim 17 is used as the developer.
